(19) United States
(12) Patent Application Publication
(10) Pub. No.: US 2026/0122571 A1
(43) Pub. Date: Apr. 30, 2026

(54) Duty Cycled Receiver for Power Savings

(71) Applicant: Silicon Laboratories Inc., Austin, TX (US)

(72) Inventor: Sagar Chinchani, Braintree, MA (US)

(21) Appl. No.: 18/930,065

(22) Filed: Oct. 29, 2024

(51) Int. Cl. H04W 52/02

(52) U.S. Cl. CPC H04W 52/0235

(57) ABSTRACT

A system and method to reduce power consumption of a battery powered device during unsynchronized Coordinated Sampled Listening (CSL) is provided. The CSL target wakes for short periods of time to detect whether there is a valid signal being transmitted. If noise is detected, the CSL target returns to sleep mode. The CSL target remains in sleep mode for an intermittent sleep period. The CSL target then wakes again during the listening interval to check again for noise. If a valid signal is detected, the CSL target remains in receive mode and attempts to receive the wake-up frame and the payload frame.

### FIELD

This disclosure describes systems and methods for reducing power consumption used during unsynchronized coordinated sampled listening (CSL).

### BACKGROUND

There are various network protocols that are based on the IEEE 802.15.4 standard. These network protocols include Thread and Zigbee, among others. One feature described in this standard is a coordinated sampled listening (CSL) feature. This CSL feature allows a sleepy end device to reduce its power consumption while attempting to synchronize to another device.

According to the IEEE 802.15.4 specification, one device, which may be referred to as a CSL initiator device, transmits a sequence of wake-up frames. These wake-up frames are typically sent one after another, for a predetermined time period. A wake-up frame includes a preamble and optionally a payload. This set of wake-up frames is referred to as a wake-up sequence. After this wake-up sequence, a payload frame is transmitted. In some embodiments, the wake-up frames each have a payload that includes a rendezvous time, which is defined as the expected length of time in milliseconds between the end of the transmission of a particular wake-up frame and the beginning of the transmission of the payload frame. This pattern of a wake-up sequence followed by a payload frame is known as a wake-up transmit interval, and may be repeated by the CSL initiator at a predetermined interval.

A second device, referred to as a CSL target, is configured to wake up periodically to listen for one or more of these wake-up frames. If no wake-up frame is detected, the CSL target returns to sleep mode. If a wake-up frame is detected, the CSL target receives the payload frame.

To coordinate the activities of these two devices, a set of parameters is defined. For example, the length of the wake-up sequence and the wake-up transmit interval are typically defined. Additionally, the duration of time that the CSL target wakes up to listen for wake-up frames is typically also defined, and may be referred to as the listening period. Finally, the duration of time that the CSL target is in sleep mode between listening periods is also defined. In general, the duration of the listening period is greater than the duration between the start of two successive wake-up frames to ensure that the CSL target is awake for at least one wake-up frame.

Typically, the duration of the listening period is rather long, such as 1 millisecond or more. This consumes a large amount of power from the CSL target, which is typically a battery powered device. A typical timing diagram of this feature is shown in FIG. 13. The CSL initiator transmits wake-up frames 1300 repeatedly during the wake-up transmit interval 1310. The CSL target wakes and listens for the wake-up frames 1300 during the listening interval 1320. In one commercial embodiment, the wake-up transmit interval is 125 milliseconds, and the listening interval is 5 milliseconds. Thus, in this embodiment, the CSL target is in sleep mode 120 millisecond/125 milliseconds or 96% of the time. However, it is in the higher power receive mode for the remaining 4% of the time, even though most of the time, there will not be any wake-up frames transmitted during the listening interval.

Therefore, it would be advantageous if there were a system and method that allowed the CSL target to detect the wake-up frame without having to be awake during the entire listening interval.

### SUMMARY

A system and method to reduce power consumption of a battery powered device during unsynchronized Coordinated Sampled Listening (CSL) is provided. The CSL target wakes for short periods of time to detect whether there is a valid signal being transmitted. If noise is detected, the CSL target returns to sleep mode. The CSL target remains in sleep mode for an intermittent sleep period. The CSL target then wakes again during the listening interval to check again for noise. If a valid signal is detected, the CSL target remains in receive mode and attempts to receive the wake-up frame and the payload frame.

According to one embodiment, a method of operating a network device during an unsynchronized coordinated sampled listening (CSL) operation is disclosed. The method comprises dividing a listening interval into active periods and intermittent sleep periods; wherein the network device is in active mode and detects and processes signals during the active periods and is in sleep mode during the intermittent sleep periods. In some embodiments, during unsynchronized CSL operation, a CSL initiator transmits one or more wake-up frames in sequence during a wake-up transmit window. In certain embodiments, the wake-up transmit window of the CSL initiator is longer than the listening interval. In certain embodiments, the network device is in sleep mode when not in the listening interval. In some embodiments, the active periods are of a duration that is sufficient to allow the network device to detect noise. In certain embodiments, a duration of each of the active periods is 16 microseconds or less. In some embodiments, a sum of a duration of an active period and a duration of an intermittent sleep period is less than or equal to a duration of a wake-up frame being transmitted by a CSL initiator. In certain embodiments, the sum of the duration of an active period and the duration of an intermittent sleep period is between 25% and 100% of the duration of the wake-up frame. In certain embodiments, the wake-up frame comprises a preamble, and the sum of the duration of the active period and the duration of the intermittent sleep period is less than or equal to a duration of the preamble of the wake-up frame being transmitted by a CSL initiator.

According to another embodiment, a network device is disclosed. The network device comprises a network interface; a noise detector; a processing unit; and a memory device in communication with the processing unit, comprising instructions, which when executed by the processing unit, enable the network device to operate in a reduced power consumption mode during a listening interval associated with unsynchronized coordinated sampled listening (CSL) operation. In some embodiments, during unsynchronized CSL operation, the network device is in active mode during a portion of a listening interval and is in sleep mode during a remainder of the listening interval. In certain embodiments, the listening interval is divided into active periods and intermittent sleep periods, wherein the network device is in active mode during the active periods and is in sleep mode during the intermittent sleep periods. In certain embodiments, the active periods are of a duration that is sufficient to allow the noise detector to detect noise. In certain embodiments, a duration of each of the active periods is 16 microseconds or less. In some embodiments, a sum of a duration of an active period and a duration of an intermittent sleep period is less than or equal to a duration of a wake-up frame being transmitted by a CSL initiator. In certain embodiments, the sum of the duration of an active period and the duration of an intermittent sleep period is between 25% and 100% of the duration of the wake-up frame. In certain embodiments, the wake-up frame comprises a preamble, and the sum of the duration of the active period and the duration of the intermittent sleep period is less than or equal to a duration of the preamble of the wake-up frame.

According to another embodiment, a system is disclosed. The system comprises a first device, referred to as a coordinated sampled listening (CSL) initiator; a second device, referred to as a CSL target; wherein the CSL initiator transmits a plurality of wake-up frames during a wake-up transmit window; and wherein the CSL target enters active mode for a portion of a listening interval and is in sleep mode for a remainder of the listening interval; wherein the listening interval is defined as being longer than a duration between starts of two successive wake-up frames and shorter than the wake-up transmit window. In some embodiments, the listening interval is divided into active periods and intermittent sleep periods; wherein the CSL target is in active mode and detects and processes signals during the active periods and is in sleep mode during the intermittent sleep periods; and wherein a sum of a duration of an active period and the duration of an intermittent sleep period is between 25% and 100% of the duration of one of the plurality of wake-up frames. In some embodiments, the duration of each of the active periods is 16 microseconds or less.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a wireless network device according to one embodiment;

FIGS. 2A-2B show block diagrams of the receive circuit according to one embodiment;

FIG. 3 shows a graph showing frequency values for noise and a valid wireless signal;

FIG. 4 shows the operation of the read circuit during a listening interval;

FIG. 5 shows the detection window according to one embodiment;

FIG. 6 shows the operation of the noise detector when using the detection window of FIG. 5;

FIG. 7 is a graph of cumulative detection rate versus detection time using the noise detector of FIG. 6;

FIG. 8 shows the detection window according to a second embodiment;

FIG. 9 shows the operation of the noise detector when using the detection window of FIG. 8;

FIG. 10 shows the detection window according to a third embodiment;

FIG. 11 shows the operation of the noise detector when using the detection window of FIG. 10;

FIG. 12 shows a block diagram of the noise detector;

FIG. 13 shows a timing diagram of a typical CSL operation;

FIG. 14 shows a flowchart showing the operation of the wireless network device during a CSL operation; and

FIG. 15 shows the timing diagram of the CSL operation using the method shown in FIG. 14.

### DETAILED DESCRIPTION

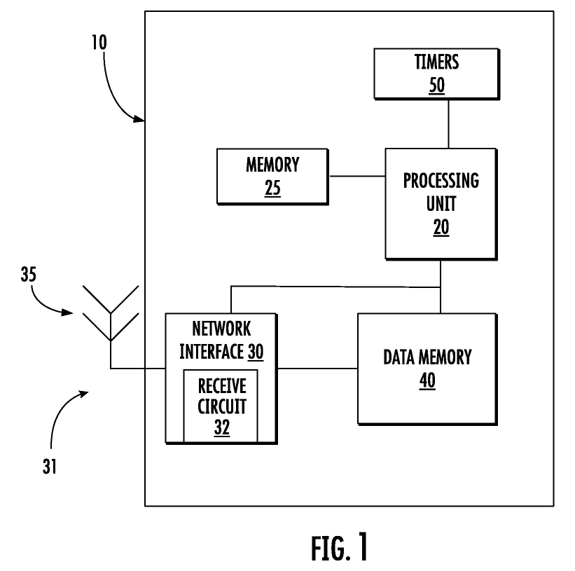

FIG. 1 shows a block diagram of a representative network device 10 that is able to reduce power consumption during an unsynchronized CSL operation. This network device 10 may be referred to as a CSL target. This network device 10 includes a noise detector, which is able to identify an invalid wireless signal, typically within 10 microseconds. This noise detector allows lower power operation of the network device during the CSL operation. Specifically, this allows the listening interval that is used in CSL operations to be divided into small active periods and longer intermittent sleep periods. The small active periods are sufficiently long so as to detect the presence of a wake-up frame. The intermittent sleep periods are of a duration that allows there to be at least one active period during each possible wake-up frame.

The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions, which, when executed by the processing unit 20, enable the network device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support any wireless network, such as Bluetooth, Wi-Fi, networks utilizing the IEEE 802.15.4 specification, such as Zigbee, Thread and Wi-SUN, networks utilizing the IEEE 802.15.6 specification, and wireless smart home protocols, such as Z-Wave. Further, the network interface 30 may also support a proprietary or custom wireless network. The network interface 30 includes a transmit circuit which is used to transmit data from this network device 10 using the antenna 35. The network interface 30 also includes a receive circuit 32 which is used to receive packets.

The network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless network 31. Although not shown, the network device 10 also has a power supply, which may be a battery or a connection to a permanent power source, such as a wall outlet.

Lastly, the network device 10 may include one or more timers 50.

While the processing unit 20, the memory device 25, the network interface 30, the timers 50 and the data memory device 40 are shown in FIG. 1 as separate components, it is understood that some or all of these components may be integrated into a single electronic component. Rather, FIG. 1 is used to illustrate the functionality of the network device 10, not its physical configuration. Further, the network device 10 may operate in a plurality of modes. In receive mode, the components of the device are powered on and are active, such that the network interface 30 is actively receiving and processing signals from the antenna 35. In sleep mode, many of the components in the network device 10 are powered off to conserve power. This includes the network interface 30 and often times, the processing unit 20. An interrupt or timer may be used to wake the network device 10 from sleep mode.

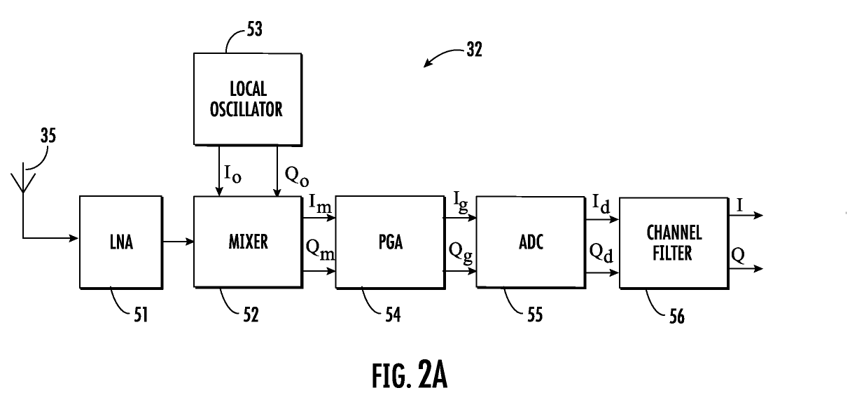

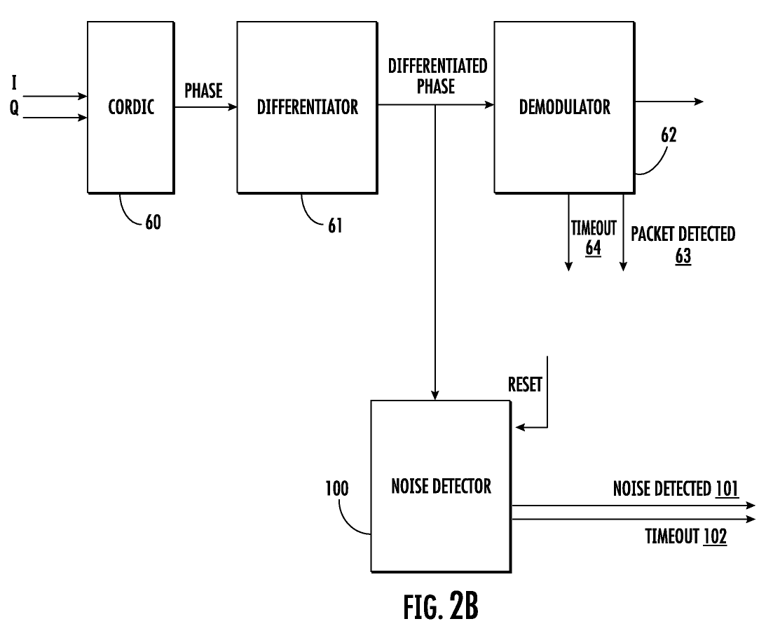

FIG. 2A-2B provide a more detailed illustration of the receive circuit 32 of the network interface 30 according to one embodiment. As shown in FIG. 2A, the wireless signals first enter the network interface 30 through the antenna 35. The antenna 35 is in electrical communication with a low noise amplifier (LNA) 51. The LNA 51 receives a very weak signal from the antenna 35 and amplifies that signal while maintaining the signal-to-noise ratio (SNR) of the incoming signal. The amplified signal is then passed to a mixer 52. The mixer 52 is also in communication with a local oscillator 53, which provides two phases to the mixer 52. The cosine of the frequency may be referred to as Iₒ, while the sine of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer 52, are then fed into programmable gain amplifier (PGA) 54. The PGA 54 amplifies the Iₘ and Qₘ signals by a programmable amount. These amplified signals may be referred to as I_{g} and Q_{g}. The amplified signals, I_{g} and Q_{g}, are then fed from the PGA 54 into an analog to digital converter (ADC) 55. The ADC 55 converts these analog signals to digital signals, I_{d} and Q_{d}. These digital signals may then pass through a channel filter 56. The filtered signals are referred to as I and Q. The output of the channel filter 56 may be referred to as the baseband signals. The components that are used to receive the signal from the antenna 35 and produce the baseband signals are referred to as the RF circuit.

These I and Q signals can be used to recreate the amplitude and phase of the original signal. In certain embodiments, the I and Q values may be considered complex numbers, wherein the I value is the real component and the Q value is the imaginary component.

As shown in FIG. 2B, the I and Q signals then enter a phase calculator, such as a CORDIC (Coordination Rotation Digital Computer) 60, which determines the amplitude and phase of the signals. Amplitude is given as the square root of I² and Q², while phase is given by the tan⁻¹ (Q/I). In some embodiments, the CORDIC 60 may be a hardware component disposed in the network interface 30. In other embodiments, the CORDIC 60 may be implemented in software. In other embodiments, a different type of phase calculator may be used.

The phase output from the CORDIC 60 is then supplied as an input to the differentiator 61. As is well known, the derivative of phase is frequency. Thus, by determining the difference between the values of two sequential phase values, and optionally dividing the difference by a time duration, a value that is indicative of frequency can be determined. In some embodiments, the differentiator 61 may be a hardware component disposed in the network interface 30. In other embodiments, the differentiator 61 may be implemented in software. The differentiated phase signal may be a signed value, such as an 8-, 16- or 32-bit signed value.

In some embodiments, additional components, which are not shown may also be included in the path from the antenna 35 to the differentiator 61.

The differentiated phase signal is used as an input to a Demodulator 62. The Demodulator 62 may have several functions. First, it may determine the frequency offset (if any) between the incoming data stream and the sample clock used by the network device 10. Another function of the Demodulator 62 may be to detect the preamble pattern. This may be performed by creating a cost function or correlator where a sequence of data samples is compared to the known preamble pattern. Yet another function of the Demodulator 62 may be to identify the synchronization pattern. This can be done by creating a cost function or correlator where a sequence of data samples is compared to the known synchronization pattern. The point at which this cost function is minimized or the correlation score is maximized is identified as the synchronization pattern. The Demodulator 62 then uses this indication to properly align the incoming bits into bytes and receive the packet. Of course, other mechanisms may be used to identify the preamble and/or synchronization patterns. An indication that a valid packet may be present is supplied as an output referred to as the packet detected indicator 63. Further, the Demodulator 62 may provide a timeout signal 64 to indicate that it did not detect a signal that may be a valid packet within a predetermined time period. These signals may be used by the processing unit 20 or a special purpose hardware component, as described below.

The differentiated phase signal is also used as an input to the noise detector 100. The noise detector 100 is a hardware circuit that is used to quickly determine whether the incoming signal contains actual data or is simply noise. Specifically, the noise detector 100 checks for noise within a detection window. The noise detector 100 may include a collection of semiconductor devices, such as adders, comparators, multiplexers and other functions, that execute the processes shown in the accompanying flowcharts. In another embodiment, the noise detector 100 may include a small processing unit to execute the process shown in the accompanying flowcharts.

The differentiated phase signal received from the differentiator 61 is oversampled. This implies that multiple samples are taken for each possible bit of data. For example, if the maximum data rate is 2Mbps, an oversample rate of 8 MHz (four times oversampling) or 10 MHz (5 times oversampling) may be used.

In certain embodiments, any frequency offset is subtracted from these frequency values. Removing the frequency offset may allow better analysis of the incoming signal. This may be done by calculating the average positive frequency of all of the data points having a positive value, calculating the average negative frequency of all of the data points having a negative value, and then taking the average of the average positive frequency and the average negative frequency. This average value may be referred to as the frequency offset. This average value may then be subtracted from all of the data points in the window. Note that in some embodiments, the frequency offset is removed prior to the noise detector 100, such that the values received by the noise detector 100 have any frequency offset removed. In other embodiments, the frequency offset is not removed.

Having processed the data points in the window, the noise detector 100 may then check for noise. For example, if the frequency value of a data point is outside a predetermined range, this may be indicative of noise. For example, Zigbee, BLE, Thread and some other protocols utilize 2 FSK (2Frequency Shift Keying), which modulates the carrier frequency (Fc) by a deviation frequency (Fd), resulting in signals with frequencies between Fc-Fd and Fc+Fd. After filtering and processing to remove the carrier frequency, the data points in the window should have values that correspond roughly to frequencies between -Fd and +Fd.

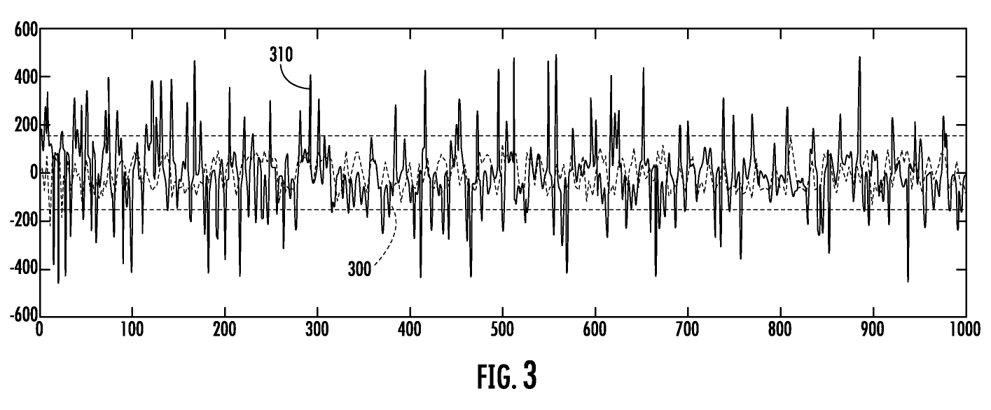

FIG. 3 shows the data points after processing and filtering. For illustrative purposes, FIG. 3 shows more than one window of data. The vertical axis represents values that are indicative of frequency. In this graph, the number 64 is used to represent +Fd and -64 represents -Fd. The dotted lines represent the threshold used to detect a frequency outlier. In certain embodiments, this threshold is programmable and may be set to any desired value. For example, in some embodiments, it may be set to a value that is 2.5 times the +Fd and -Fd values. In this graph, line 300 represents actual data. Note that the line 300 remains within the range defined by the two dotted lines. The line 310 represents the lack of a valid signal and has frequency values well in excess of +Fd and -Fd. In fact, these values are in excess of +200 and -200 (in other words, more than twice +Fd and -Fd).

Thus, if the data points have values that indicate frequencies well above +Fd or well below -Fd, this may be indicative of noise. In certain embodiments, the noise detector 100 allows some amount of margin, such as 80-200%. In the case of 100% margin, frequency outliers are those frequency values that are greater than twice +Fd or less than twice -Fd. This amount of margin, which may be programmable, is denoted as max_margin. If the max_margin is a value greater than 1, then each point having a frequency above max_margin * +Fd or below max_margin * -Fd may be referred to as a frequency outlier.

The noise detector 100 operates by counting the number of these frequency outliers within a predetermined detection window. If the number of frequency outliers exceeds some predetermined threshold, the noise detector 100 provides an output 101 that indicates that noise has been detected. This output 101 may be provided to the processing unit 20 or another special purpose hardware component. This output 101 is used to notify the processing unit 20 that it may return to sleep mode since a valid signal is not present on this channel. Additionally, the noise detector 100 may provide a timeout signal 102, that indicates that noise was not detected during the predetermined time period. This signal may also be used by the processing unit 20.

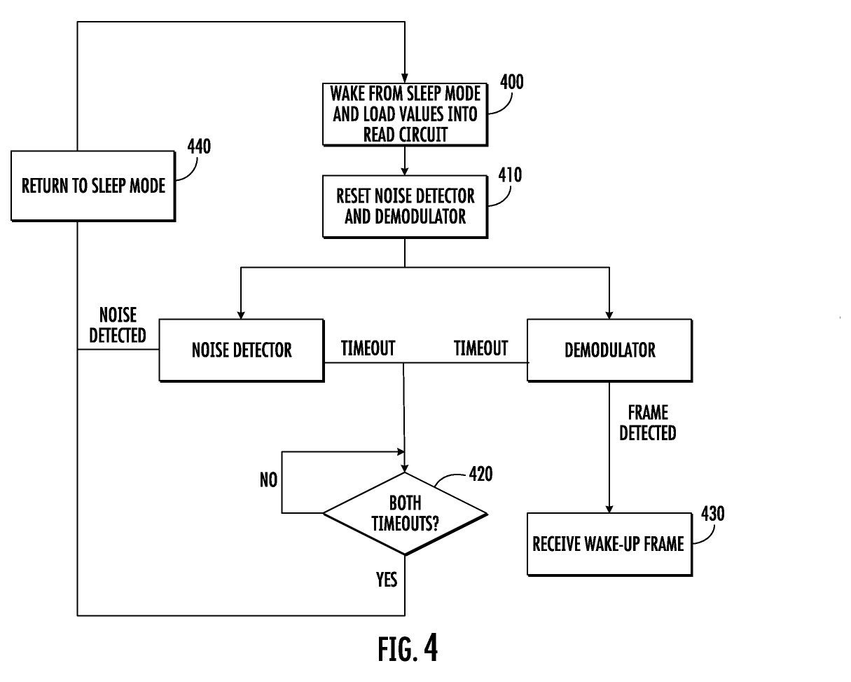

FIG. 4 shows how the noise detector 100 cooperates with the processing unit 20 and the rest of the receive circuit 32 to receive packets. First, as shown in Box 400, the device exits sleep mode and the receive circuit 32 and the demodulator 62 are initialized with the parameters needed to receive a signal. This may be a Zigbee channel, a Thread channel or a channel on some other wireless protocol. These parameters may include the setting of bandwidth, center frequency, oversample rate, and others. Then, the processing unit 20 resets the noise detector 100 and the demodulator 62, as shown in Box 410. As described herein, the noise detector 100 is used to check for noise. As noted above, the noise detector 100 may count the number of frequency outliers within a detection window. There are two possible results from the noise detector 100. If, after the completion of a predetermined time period, the noise detector 100 does not detect noise, the noise detector 100 reports a timeout. However, if the noise detector 100 determines that there is noise, the network device may return to sleep mode, as shown in Box 440. If the noise detector 100 does not determine that there is noise within some predetermined time period, such as 10-16 μsec, the device moves to Decision Box 420. While the noise detector 100 is checking for noise, the received data is simultaneously being processed by the demodulator 62. Specifically, the demodulator 62 may be used to determine whether a pattern that may represent a valid packet is present. If the demodulator detects a valid packet has been detected, then the rest of the wake-up frame is received, as shown in Box 430. If the demodulator does not detect a valid packet within some predetermined time period, then the device moves to Decision Box 420. If both components have reported timeouts, then the device returns to sleep mode, as shown in Box 440, as a valid wake-up frame was not detected.

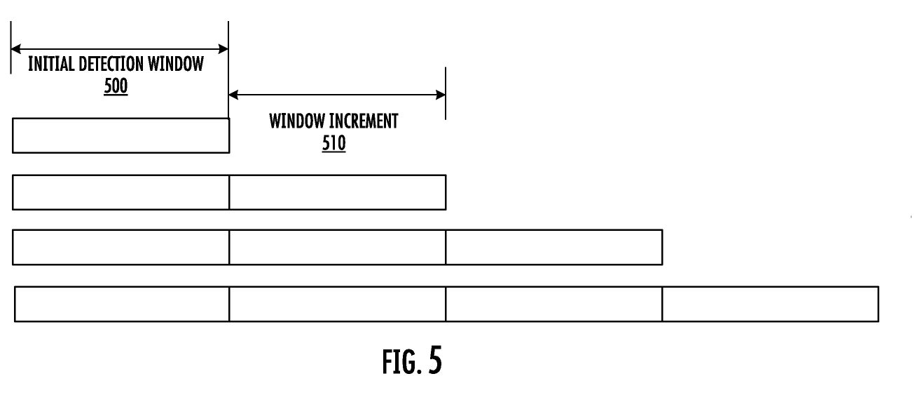

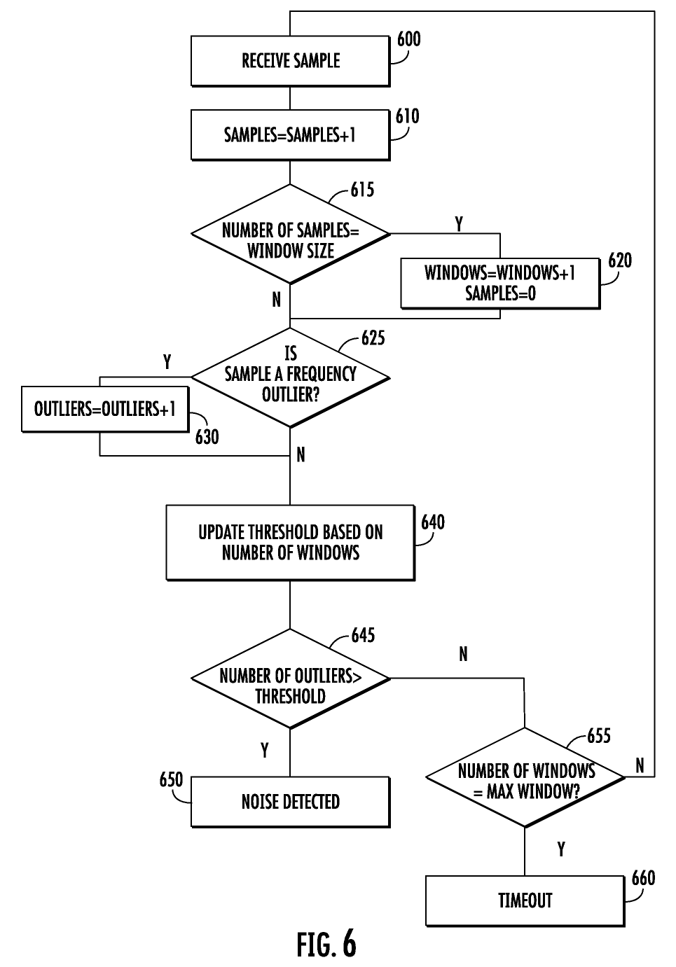

A detailed description of the noise detector 100 is now provided. As explained above, the noise detector 100 operates by counting the number of frequency outliers within a window. FIG. 5 shows one embodiment of the noise detector 100, which utilizes an incremental detection window. The term “incremental detection window” refers to an expanding detection window, which begins with an initial detection window 500 having a first duration and continues to grow unless noise is detected. The detection window may grow by a duration referred to as the window increment 510, which may be the same duration as the initial detection window 500 or may be a different duration. As the size of the detection window grows, the number of frequency outliers that are acceptable also grows. For example, the noise detector 100 may be configured to detect noise if there are 4 frequency outliers within the first 4 μsec. If there is no noise, the noise detector 100 may then update the threshold to detect noise if there are 8 frequency outliers within the first 8 μsec. FIG. 6 shows a flowchart which explains the operation of the noise detector 100 when utilizing an incremental detection window.

First, as shown in Box 600, a new sample is received. As described above, this sample may be a value that represents a frequency of the incoming signal. Then, in Box 610, the number of samples received is incremented. Decision Box 615 checks if the number of samples is equal to the size of a window. If so, the number of windows received is incremented and the sample count is reset, as shown in Box 620. In either scenario, the noise detector 100 then compares the sample to the allowable frequency values, as explained above and shown in Decision Box 625. If the sample is outside the allowable frequency range, the number of frequency outliers is incremented, as shown in Box 630. The threshold is updated based on the number of windows that have been received, as shown in Box 640. Note that the threshold may be updated earlier, such as after Box 620, if desired. The noise detector 100 then compares the number of frequency outliers to the threshold, as shown in Decision Box 645. If the number of frequency outliers exceeds the threshold, the noise detector 100 reports that noise has been detected, as shown in Box 650. If the number of frequency outliers is less than the threshold, the noise detector 100 checks if all of the windows have been received, as shown in Decision Box 655. If so, the noise detector 100 terminates operation and reports a timeout, as shown in Box 660. Thus, in this embodiment, the predetermined time period described in FIG. 4 refers to the maximum number of windows that are combined to form the final detection window used by the noise detector 100. If all of the windows have not been received yet, the sequence is repeated.

Note that the flowchart shown in FIG. 6 may be modified. For example, the noise detector 100 may utilize the number of samples (rather than the number of windows) to determine the appropriate threshold to use. This may allow finer resolution, if desired. Further, in certain embodiments, the number of frequency outliers are only compared to the threshold after a full window has been received.

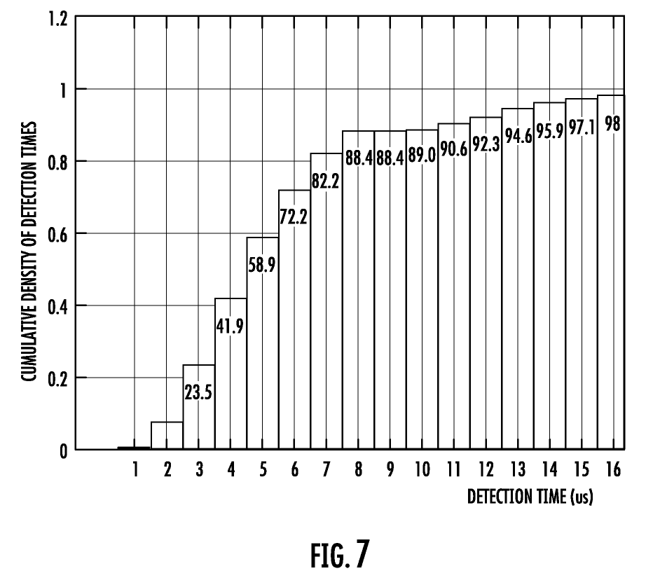

FIG. 7 shows the benefits of this approach when attempting to detect a Bluetooth signal. The vertical axis represents the cumulative detection rate, defined as the rate at which the presence of noise is correctly identified. The horizontal axis represents the detection time. Note that the detection rate is relatively low at detection times less than 6 μsec, but increases to over 80% at detection times of 8 μsec or more. Further, referring back to FIGS. 5-6, the window may be set to any desired value. For example, in some embodiments, the noise detector 100 may operate on up to sixteen 1 μsec windows, such that the threshold changes as the number of windows increases. In other embodiments, the noise detector 100 may operate on up to eight 2 μsec windows or four 4 μsec windows.

As an example, the noise detector 100 may operate using a detection window of 16 μsec, wherein the threshold for frequency outliers is changed every 1, 2 or 4 μsec. For example, a first threshold is used for times less than 2 μsec, a second threshold is used for times between 2 and 4 μsec, and so on. In other embodiments, the detection window may be 10 μsec, which allows roughly a 90% probability of detecting the wake-up frame.

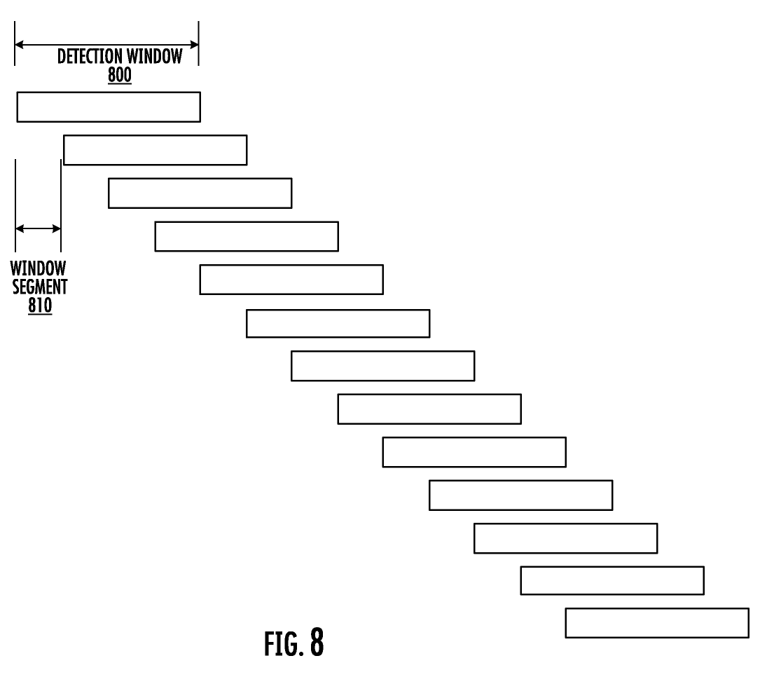

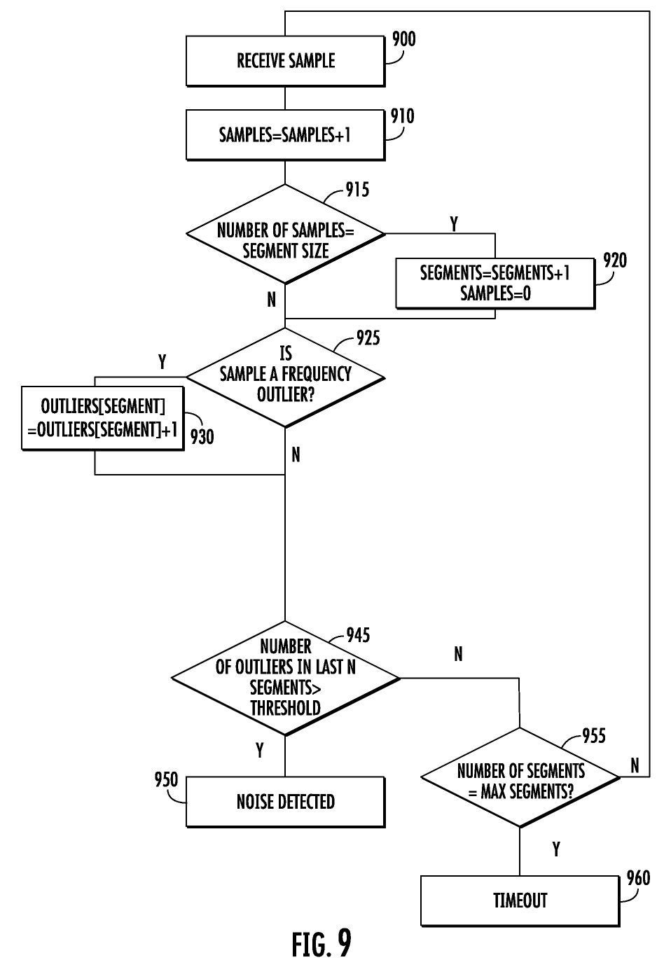

Note that other detection schemes may be used. For example, a sliding detection window may be used. FIG. 8 shows an example of a sliding detection window. In this embodiment, a detection window 800 is made up of one or more window segments 810, such that the detection window 800 equals N window segments 810. Further, the detection window 800 slides by an amount equal to one window segment 810. Thus, the size of the detection window 800 is fixed, but its position in time moves. FIG. 9 shows a flowchart that details this operation. First, as shown in Box 900, a new sample is received. As described above, this sample may be a value that represents a frequency of the incoming signal. Then, in Box 910, the number of samples received is incremented. Decision Box 915 checks if the number of samples is equal to the size of a window segment 810. If so, the number of window segments received is incremented and the sample count is reset, as shown in Box 920. In either scenario, the noise detector 100 then compares the sample to the allowable frequency values, as explained above and shown in Decision Box 925. If the sample is outside the allowable frequency range, the number of frequency outliers for this window segment is incremented, as shown in Box 930. The noise detector 100 then compares the number of frequency outliers received in the last N window segments to the threshold, as shown in Decision Box 945. If the number of frequency outliers exceeds the threshold, the noise detector 100 reports that noise has been detected, as shown in Box 950. If the number of frequency outliers is less than the threshold, the noise detector 100 checks if all of the window segments 810 have been received, as shown in Decision Box 955. If so, the noise detector 100 terminates operation and reports a timeout, as shown in Box 960. If all of the window segments have not been received yet, the sequence is repeated. Thus, in this embodiment, the predetermined time period described in FIG. 4 refers to the maximum number of window segments 810 that are processed before the noise detector 100 reports a timeout.

Note that the number of window segments that are in a detection window is implementation specific and is not limited by this disclosure. In some embodiments, N is greater than 1. For example, in one specific embodiment, the detection window 800 may be 4 or 8 μsec, while each window segment 810 may be 1 μsec or 2 μsec.

Further, as noted above, in some embodiments, the number of frequency outliers is compared to the threshold only after a full window segment has been received. In other embodiments, such as described above, the number of frequency outliers is compared to the threshold after each sample.

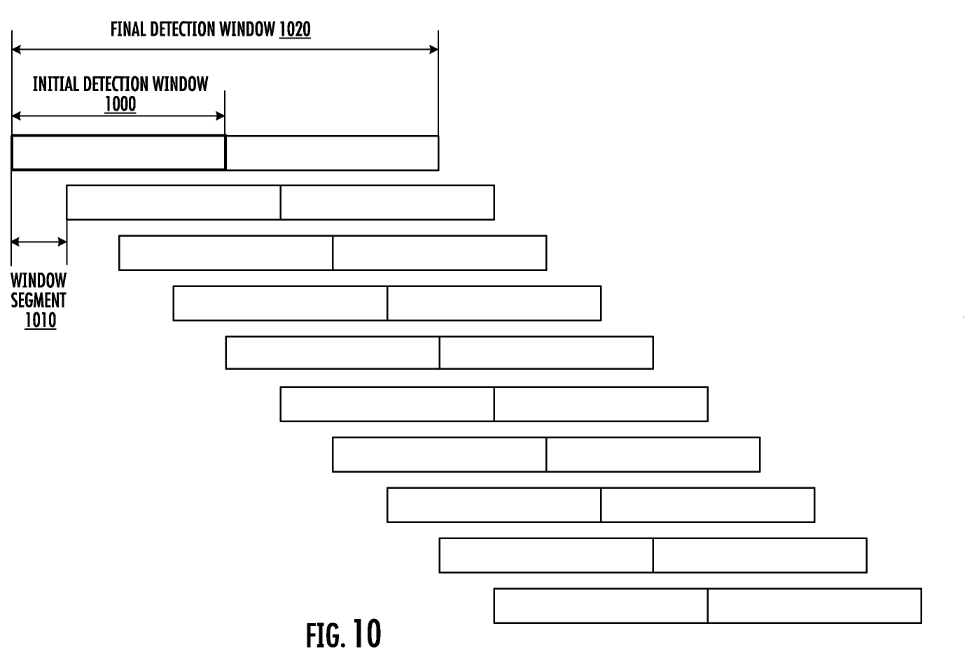

Further, in another embodiment, the previous two concepts may be combined such that the detection window grows in duration and then slides. In this embodiment, shown in FIG. 10, there is an initial detection window 1000, which has a first duration and is made up of one or more (N) window segments 1010. This initial detection window 1000 may grow in duration, similar to that described in FIGS. 5-6, to a final detection window 1020. After reaching this duration, the final detection window 1020 then slides by one window segment 1010, as explained in FIGS. 8-9. For example, in one embodiment, the initial detection window 1000 may be 4 μsec, the final detection window 1020 may be 8 or 12 μsec and the window segment 1010 may be 1 μsec or 2 μsec.

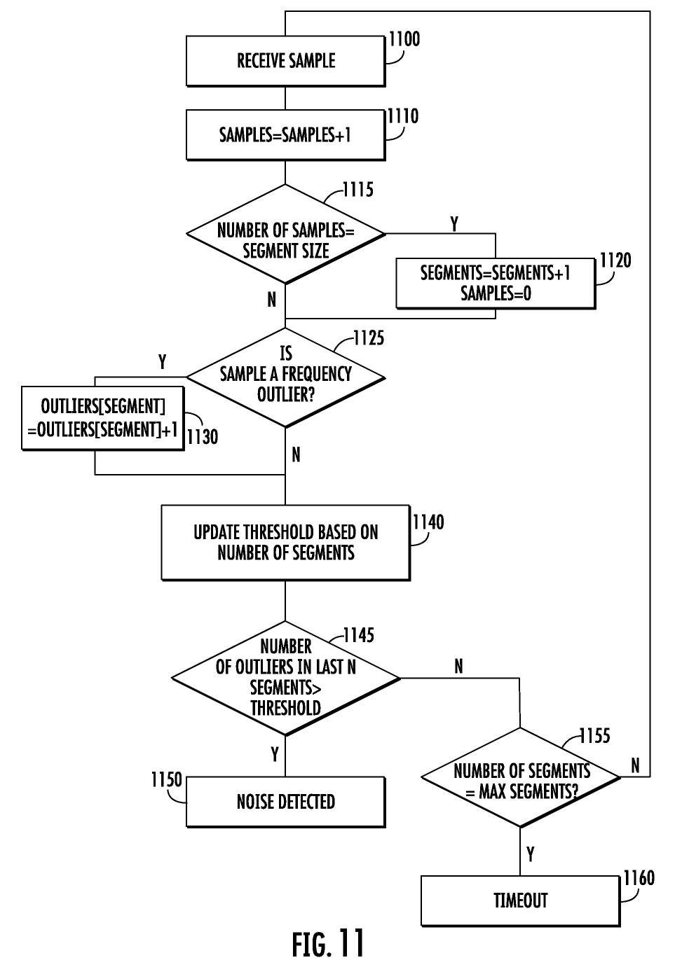

This is shown in FIGS. 10 and 11. First, as shown in Box 1100, a new sample is received. As described above, this sample may be a value that represents a frequency of the incoming signal. Then, in Box 1110, the number of samples received is incremented. Decision Box 1115 checks if the number of samples is equal to the size of a window segment 1010. If so, the number of window segments received is incremented and the sample count is reset, as shown in Box 1120. In either scenario, the noise detector 100 then compares the sample to the allowable frequency values, as explained above and shown in Decision Box 1125. If the sample is outside the allowable frequency range, the number of frequency outliers for this window segment 1010 is incremented, as shown in Box 1130. The noise detector 100 updates the threshold based on the number of window segments 1010 that have been received, as shown in Box 1140. For example, a first threshold may be used when there are fewer than M window segments, while a second threshold may be used if there are greater than M window segments that have been received. The noise detector 100 then compares the number of frequency outliers received in the last N window segments to the threshold, as shown in Decision Box 1145. If the number of frequency outliers exceeds the threshold, the noise detector 100 reports that noise has been detected, as shown in Box 1150. If the number of frequency outliers is less than the threshold, the noise detector 100 checks if all of the window segments 1010 have been received, as shown in Decision Box 1155. If so, the noise detector 100 terminates operation and reports a timeout, as shown in Box 1160. If all of the window segments have not been received yet, the sequence is repeated. Thus, in this embodiment, the predetermined time period described in FIG. 4 refers to the maximum number of window segments 1010 that are processed before the noise detector 100 reports a timeout.

Further, as noted above, in some embodiments, the number of frequency outliers is compared to the threshold only after a full window has been received. In other embodiments, such as described above, the number of frequency outliers is compared to the threshold after each sample.

As a specific example, assume that the window segment 1010 is 1 μsec, the initial detection window 1000 is 4 μsec and the final detection window 1020 is 8 μsec. In this example, the first threshold may be used when 4 or fewer window segments 1010 have been received. The second threshold may be used when more than 4 window segments 1010 have been received. Further, the detection window slides once it reaches 8 μsec.

In another example, assume that the window segment 1010 is 1 μsec, the initial detection window 1000 is 4 μsec and the final detection window 1020 is 12 μsec. In this example, the first threshold may be used when 4 or fewer window segments 1010 have been received. A second threshold may be used when more than 4 window segments and less than or equal to 8 window segments have been received. A third threshold may be used when more than 8 window segments have been received. Further, the detection window slides once it reaches 12 μsec. Thus, in this example, the detection window grows from 4 μsec, to 8 μsec, to a final window of 12 μsec, which then slides.

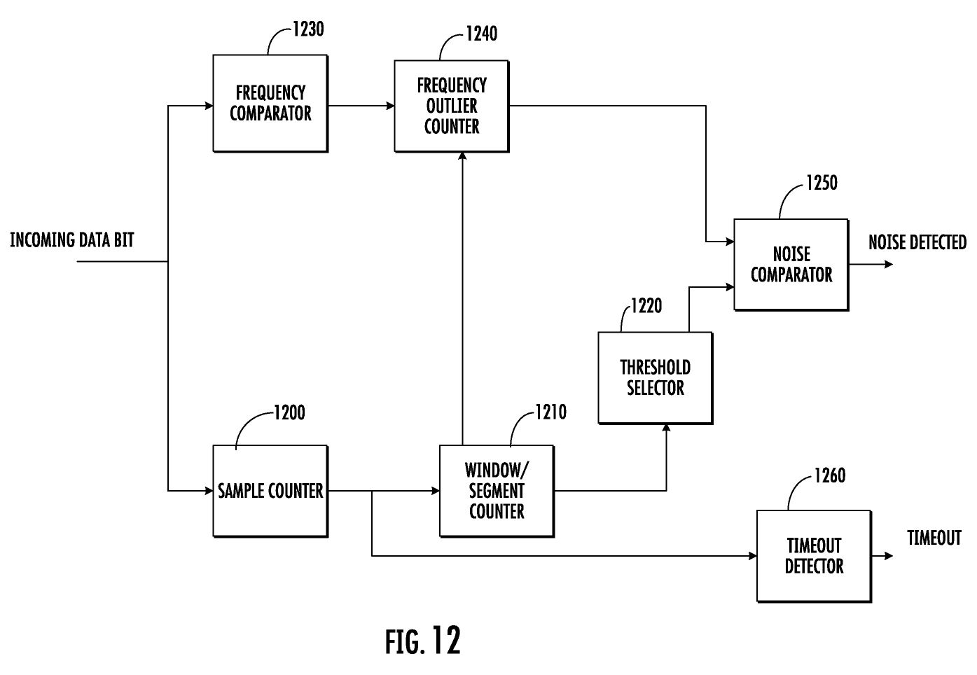

FIG. 12 shows a block diagram showing the configuration of the noise detectors described in FIGS. 5-6 and 8-11. Note that in certain embodiments, more or fewer components may be used. First, as described above, the incoming data point, which is a value representative of a frequency, is received by the sample counter 1200, which counts the number of data samples that have been received. The incoming data point is also received by a frequency comparator 1230, which compares the value of the data point to a range of expected values. As explained above, data points having values outside the range of expected values are identified as frequency outliers. The output from the frequency comparator 1230 is provided to the frequency outlier counter 1240, which counts the number of frequency outliers. In some embodiments, the frequency outlier counter 1240 counts a total number of frequency outliers; in other embodiments, the frequency outlier counter 1240 counts the number of frequency outliers in each window or segment (as is done in FIGS. 8-11).

Additionally, in some embodiments, the noise detector includes a window/segment counter 1210, which receives the output from the sample counter 1200 and tracks the number of windows or segments that have been received. For example, in FIGS. 5-6, this serves as a window counter, while in FIGS. 8-9, this serves as a segment counter. In certain embodiments, such as that shown in FIGS. 8-9, the output from the window/segment counter 1210 may be provided as an input to the frequency outlier counter 1240 so that the number of frequency outliers per segment can be tracked.

In some embodiments, such as that shown in FIGS. 5-6 and 10-11, the output from the window/segment counter 1210 or the sample counter 1200 may be provided to the threshold selector 1220 so that the threshold may be varied as a function of the number of windows or samples. In other embodiments, such as that shown in FIGS. 8-9, the threshold selector 1220 may not use any inputs; rather, the threshold may be a constant. In either embodiment, the threshold selector 1220 provides a threshold, which is then compared to the output or outputs from the frequency outlier counter 1240 by noise comparator 1250. If the number of frequency outliers is greater than the threshold, then the noise detector 100 asserts the noise detected output 101. Finally, there may be a timeout detector 1260, which is used to indicate that the noise detector did not find noise in the predetermined time duration.

Although not shown, in other embodiments, the noise detector 100 may have a fixed detection window with a predetermined threshold. In this embodiment, the noise detector 100 makes decisions about noise based on the number of frequency outliers in the fixed detection window. In this embodiment, the window/segment counter 1210 and the threshold selector 1220 shown in FIG. 12 may be omitted.

This noise detector 100 may be used by the network device 10 to further reduce power consumption during the unsynchronized CSL operation.

Specifically, rather than remaining awake during the entirety of the listening interval, the network device 10 may only remain awake during a small part of the listening interval. Thus, the listening interval is divided into a plurality of active periods, where the network device 10 is receiving and processing an incoming signal from the antenna, and intermittent sleep periods, where the network device 10 is in sleep mode. Because the noise detector 100 is able to detect the absence of a valid signal within a small period of time, such as less than 16 μseconds, it is not necessary to remain awake continuously throughout the entire listening interval. Instead, as long as the network device 10 is awake at least a portion of each wake-up frame, it will be able to determine that a wake-up sequence is occurring.

Thus, in one embodiment, the network device uses a detection window of N microseconds, where N may be 16 or less. The detection window defines the duration of the active period. The network device 10 then sets the timer 50 to a value that is smaller in duration than the duration of a wake-up frame. This is referred to the intermittent sleep timer. In certain embodiments, the sum of the durations of the detection window and the intermittent sleep timer are equal to or less than the duration of the wake-up frame. For example, the sum of the durations may be between 25% and 100% of the duration of the wake-up frame. Further, in certain embodiments, the sum of the durations may be less than the duration of the preamble of a wake-up frame. This may improve the chances that the network device is able to receive the wake-up frame since it was awake during at least part of the preamble. During the listening interval, the network device 10 switches between intermittent sleep mode (for a duration established by the intermittent sleep timer) and the receiving mode (for a duration determined by the detection window). If noise is detected while in receiving mode, the network device returns to sleep mode. If noise is not detected, the network device 10 stays awake and attempts to receive the frame that is being transmitted. If it was not successful in receiving the frame, the network device 10 may remain awake to receive the next wake-up frame being transmitted. After the listening interval is complete, the network device returns to sleep mode for the remainder of the wake-up transmit window.

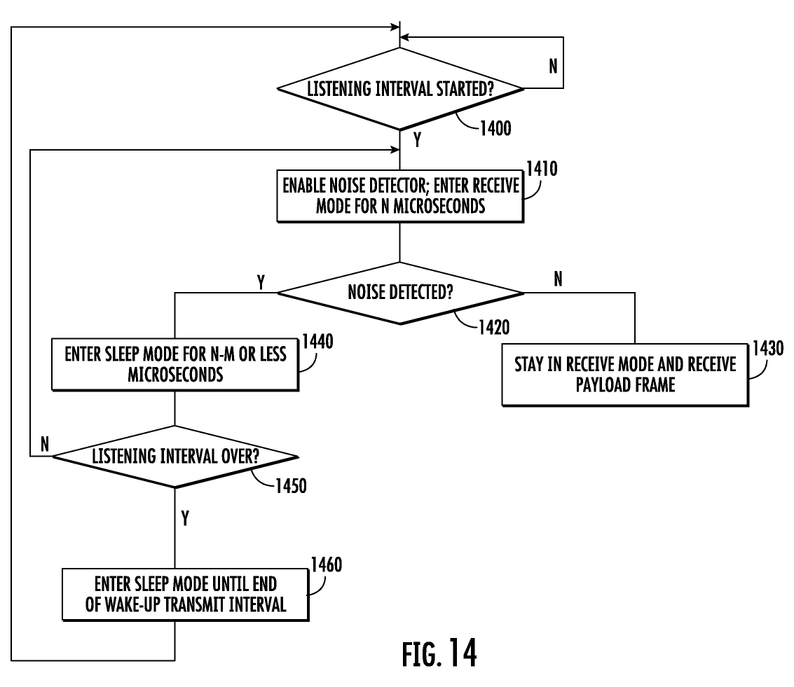

FIG. 14 shows a flowchart showing the operation of the network device 10 during the unsynchronized CSL operation. As noted above, CSL is a feature of the 802.15.4 specification, which includes protocols such as Zigbee and Thread. In this example, it is assumed that each wake-up frame sent by the CSL initiator is at least M microseconds in length. Further, the CSL initiator transmits one or more wake-up frames during each wake-up transmit window. In this example, the detection window is set to N microseconds, wherein N is less than M, and the intermittent sleep timer is set to a value equal to or less than M-N microseconds. Finally, the listening interval is set to a value that is smaller than the wake-up transmit window. First, as shown in Decision Box 1400, the network device 10 is in sleep mode, waiting for the listening interval to begin. Once the listening interval begins, the network device 10 wakes up, enables the noise detector 100 and enters receive mode, as shown in Box 1410. As noted above, the noise detector 100 has a detection window of N microseconds. At the end of the detection window, the network device 10 checks the status of the noise detector 100, as shown in decision Box 1420. If the noise detector 100 did not detect noise, this may be because a wake-up frame is being transmitted. In this case, the network device 10 remains in receive mode, receives the wake-up frame and the payload frame, as shown in Box 1430. If the noise detector 100 detected noise, a wake-up frame is not present, and the network device 10 enters sleep mode, as shown in Box 1440. As noted above, the intermittent sleep timer may be set to a value equal to or smaller than N-M microseconds. In this way, the noise detector 100 will be active during at least a portion of each wake-up frame. If the listening interval is not over, the network device returns to Box 1410 and repeats the sequence, which comprises an active period and an intermittent sleep period. If the listening interval is over, as shown in Decision Box 1450, the network device 10 enters sleep mode for the remainder of the wake-up transmit interval, as shown in Box 1460.

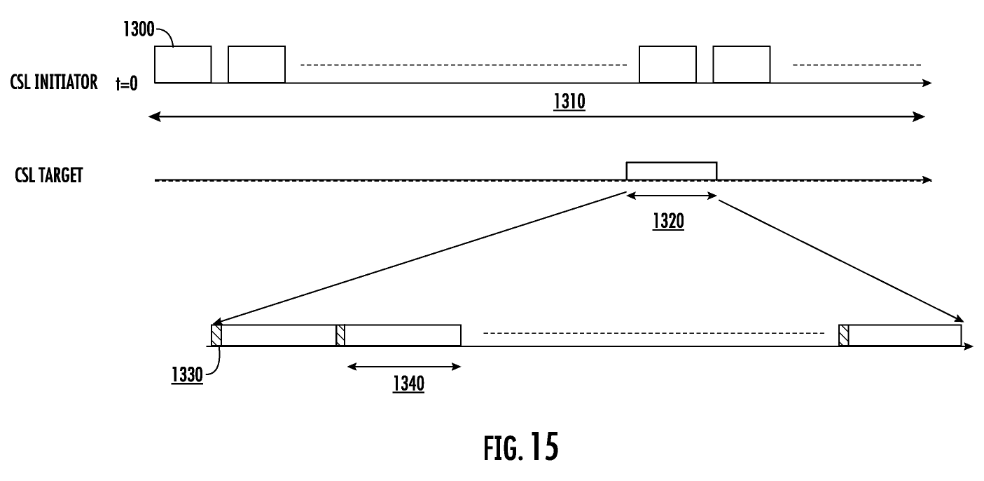

FIG. 15 shows a timing diagram showing the operation of the network device using the flowchart of FIG. 14. As can be seen, during the listening interval 1320, there are active periods 1330 where the network device is in receive mode and the noise detector 100 is enabled, and intermittent sleep periods 1340 between the active periods 1330 where the network device is in sleep mode.

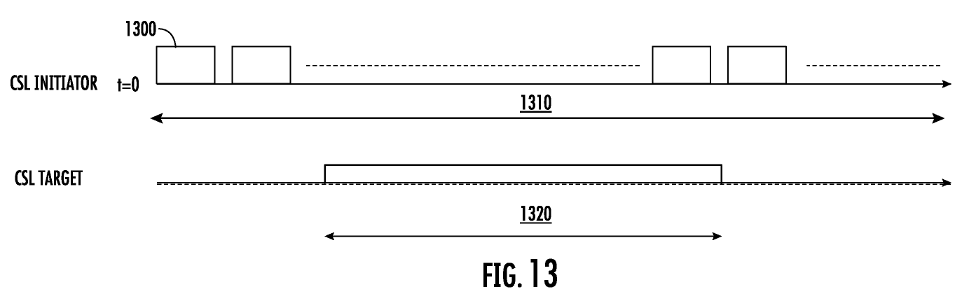

The present system has many advantages. First, this system and method is compatible with any network protocol that is based on IEEE 802.15.4, including Zigbee and Thread. Secondly, this approach results in a large power savings. As an example, assume that the active mode of the network device consumes 1000 times more power than the sleep mode. For example, assume that the average current during the active mode is 5 milliamps and is 5 microamps in sleep mode. Also assume that the listening interval is 1 millisecond and the wake-up transmit interval is 125 milliseconds. Finally, assume that the ratio of N to M is 0.1 or less. For a traditional CSL operation, such as that shown in FIG. 13, the average current may be computed as (124 milliseconds * 5 microamps + 1 millisecond * 5 milliamps)/ 125 milliseconds, or 0.045 milliamps. However, using the technique shown in FIGS. 14-15, the average current may be computed as (124 milliseconds * 5 μamps + 1 millisecond * ( N/M * 5 milliamps +(M-N)/M * 5 μamps))/125 milliseconds, or 0.009 milliamps. If it is assumed that most of the time is spent in unsynchronized CSL operation, the battery life of the network device using the techniques of FIGS. 14-15 is at least 5 times longer than that of a traditional network device.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of operating a network device during an unsynchronized coordinated sampled listening (CSL) operation, comprising:
dividing a listening interval into active periods and intermittent sleep periods; wherein the network device is in active mode and detects and processes signals during the active periods and is in sleep mode during the intermittent sleep periods.

2. The method of claim 1, wherein during unsynchronized CSL operation, a CSL initiator transmits one or more wake-up frames in sequence during a wake-up transmit window.

3. The method of claim 2, wherein the wake-up transmit window of the CSL initiator is longer than the listening interval.

4. The method of claim 3, wherein the network device is in sleep mode when not in the listening interval.

5. The method of claim 1, wherein the active periods are of a duration that is sufficient to allow the network device to detect noise.

6. The method of claim 5, wherein a duration of each of the active periods is 16 microseconds or less.

7. The method of claim 1, wherein a sum of a duration of an active period and a duration of an intermittent sleep period is less than or equal to a duration of a wake-up frame being transmitted by a CSL initiator.

8. The method of claim 7, wherein the sum of the duration of an active period and the duration of an intermittent sleep period is between 25% and 100% of the duration of the wake-up frame.

9. The method of claim 7, wherein the wake-up frame comprises a preamble, and the sum of the duration of the active period and the duration of the intermittent sleep period is less than or equal to a duration of the preamble of the wake-up frame being transmitted by a CSL initiator.

10. A network device, comprising:
a network interface;
a noise detector;
a processing unit; and
a memory device in communication with the processing unit, comprising instructions, which when executed by the processing unit, enable the network device to operate in a reduced power consumption mode during a listening interval associated with unsynchronized coordinated sampled listening (CSL) operation.

11. The network device of claim 10, wherein during unsynchronized CSL operation, the network device is in active mode during a portion of a listening interval and is in sleep mode during a remainder of the listening interval.

12. The network device of claim 11, wherein the listening interval is divided into active periods and intermittent sleep periods, wherein the network device is in active mode during the active periods and is in sleep mode during the intermittent sleep periods.

13. The network device of claim 12, wherein the active periods are of a duration that is sufficient to allow the noise detector to detect noise.

14. The network device of claim 13, wherein a duration of each of the active periods are 16 microseconds or less.

15. The network device of claim 12, wherein a sum of a duration of an active period and a duration of an intermittent sleep period is less than or equal to a duration of a wake-up frame being transmitted by a CSL initiator.

16. The network device of claim 15, wherein the sum of the duration of an active period and the duration of an intermittent sleep period is between 25% and 100% of the duration of the wake-up frame.

17. The network device of claim 15, wherein the wake-up frame comprises a preamble and the sum of the duration of the active period and the duration of the intermittent sleep period is less than a duration of the preamble of the wake-up frame.

18. A system, comprising:
a first device, referred to as a coordinated sampled listening (CSL) initiator;
a second device, referred to as a CSL target;
wherein the CSL initiator transmits a plurality of wake-up frames during a wake-up transmit window; and
wherein the CSL target enters active mode for a portion of a listening interval and is in sleep mode for a remainder of the listening interval;
wherein the listening interval is defined as being longer than a duration between starts of two successive wake-up frames and shorter than the wake-up transmit window.

19. The system of claim 18, wherein the listening interval is divided into active periods and intermittent sleep periods; wherein the CSL target is in active mode and detects and processes signals during the active periods and is in sleep mode during the intermittent sleep periods; and wherein a sum of a duration of an active period and the duration of an intermittent sleep period is between 25% and 100% of the duration of one of the plurality of wake-up frames.

20. The system of claim 19, wherein the duration of each of the active periods is 16 microseconds or less.
